(19) United States
(12) Patent Application Publication
(10) Pub. No.: US 2013/0112653 A1
(43) Pub. Date: May 9, 2013

(54) Apparatus and Method for Processing Glass Window of Display

(71) Applicant: Sung-Ki JANG, Yongin-City (KR)

(72) Inventor: Sung-Ki JANG, Yongin-City (KR)

(73) Assignee: SAMSUNG MOBILE DISPLAY CO., LTD., Yongin-City (KR)

(21) Appl. No.: 13/345,000

(22) Filed: Jan. 6, 2012

(30) Foreign Application Priority Data
Nov. 4, 2011 (KR) 10-2011-0114624

(51) Int. Cl. C03C 15/00

(52) U.S. Cl. 216/24; 156/345.21; 156/345.19

(57) ABSTRACT

In a display glass window processing device and a method thereof, the display glass window processing device includes a worktable for supporting an unprocessed glass, a rotator for rotating the unprocessed glass, and a sprayer for spraying an etchant onto the unprocessed glass. A first protection film attached to one side of the unprocessed glass arranged opposite the sprayer, and a second protection film is attached to another side of the unprocessed glass arranged opposite the worktable. The first protection film exposes an edge of the unprocessed glass so that the edge is etched by the etchant so as to become rounded.

### CLAIM OF PRIORITY

This application makes reference to, incorporates the same herein, and claims all benefits accruing under 35 U.S.C. §119 from an application earlier filed in the Korean Intellectual Property Office on the 4^{th} of Nov. 2011 and there duly assigned Serial No. 10-2011-0114624.

### BACKGROUND OF THE INVENTION

1. Field of the Invention

The present invention relates generally to a device for processing a glass window of a display and a method thereof. More particularly, the present invention relates to a display glass window processing device that can effectively process a glass using an etchant, and a method thereof.

2. Description of the Related Art

A display, such as an organic light emitting diode display element, a liquid crystal display element, and an electrophoretic display (EPD) element, includes a glass disposed in a front surface where an image is displayed.

The glass window can be processed into various shapes as necessary, and a diamond electrodepositing tool or a thermoforming method is used to process the glass window.

However, when the diamond electrodepositing tool is used to process the glass window, the process may be complicated and the processing speed is slowed down. In addition, when the diamond electrodepositing tool is used to process the glass window, a haze is generated in the surface of the glass, and thus an additional grinding process is required. In addition, the thermoforming method is inefficient because it causes an increase in processing cost.

The above information disclosed in this Background section is only for enhancement of an understanding of the background of the described technology, and therefore it may contain information that does not form the prior art that is already known in this country to a person of ordinary skill in the art.

### SUMMARY OF THE INVENTION

The present invention has been developed in an effort to provide a display glass window processing device and a method thereof for effective processing of glass using an etchant.

A display glass window processing device according to an exemplary embodiment of the invention includes a worktable for supporting an unprocessed glass, a rotator for rotating the unprocessed glass, and a sprayer for spraying an etchant onto the unprocessed glass.

The display glass window processing device may further include a first protection film attached to one side of the unprocessed glass arranged opposite the sprayer, and a second protection film attached to the other side of the unprocessed glass arranged opposite the worktable.

The first protection film may be smaller in size than the second protection film.

The first protection film may be attached to a part of one side of the unprocessed glass, and the second protection film may be wholly attached to the other side of the unprocessed glass.

The first protection film may be attached to the unprocessed glass so as to expose an edge thereof.

The edge of the unprocessed glass may be etched so as to be rounded.

The unprocessed glass exposed to, rather than being covered by, the first protection film may be relatively and gradually etched as it moves away from the rotator.

The degree of etching may be proportional to the rotation speed of the worktable.

The first protection film and the second protection film may be etching-resistive relative to the etchant.

In the display glass window processing device, the first protection film may have formed therein an opening pattern including at least one of a diagram, a sign, a number, and a character.

According to another exemplary embodiment of the invention, a method for processing a display glass window is provided. The method includes mounting an unprocessed glass on a worktable, rotating the unprocessed glass, and spraying an etchant onto the unprocessed glass.

The method may further include, before the spraying of the etchant, attaching a first protection film to one side of the unprocessed glass arranged opposite the spryer, and attaching a second protection film to the other side of the unprocessed glass arranged opposite the worktable.

The first protection film may be smaller in size than the second protection film.

The first protection film may be attached to a part of the unprocessed glass and the second protection film may be wholly attached to the other side of the unprocessed glass. The first protection film may be attached so as to expose an edge of the unprocessed glass.

The edge of the unprocessed glass may be etched so as to be rounded.

The unprocessed glass exposed to, rather than being covered by, the first protection film may be relatively and gradually etched as it moves away from the rotator.

The degree of etching may be proportional to the rotation speed of the worktable.

The first protection film and the second protection film may be etching-resistive relative to the etchant.

In the method for processing the display glass window, the first protection film may have formed therein an opening pattern including at least one of a diagram, a sign, a number, and a character.

According to the exemplary embodiments, the display glass window processing device and the method can effectively etch glass using an etchant.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a glass window of a display processed according to a first exemplary embodiment of the invention.

FIG. 2 is a perspective view of a device for processing the display glass window according to the first exemplary embodiment of the invention.

FIG. 3 and FIG. 4 are side views sequentially illustrating a method for processing a display glass window according to the first exemplary embodiment of the invention.

FIG. 5 is a partial cross-sectional view of the display glass window processed according to the first exemplary embodiment of the invention.

FIG. 6 is a perspective view of a device for processing a display glass window according to a second exemplary embodiment of the invention.

### DETAILED DESCRIPTION OF THE INVENTION

Hereinafter, exemplary embodiments will be described in detail with reference to the attached drawings so that the present invention can be easily put into practice by those skilled in the art. The present invention is not limited to the exemplary embodiments, but may be embodied in various forms.

Like reference numerals designate like elements throughout the specification. In exemplary embodiments other than the first exemplary embodiment, elements different from those of the first exemplary embodiment will be described.

The drawings are schematic and not proportionally scaled down. Relative scales and ratios in the drawings are enlarged or reduced for the purpose of accuracy and convenience, and the scales are random and not limited thereto. In addition, like reference numerals designate like structures, elements, or parts throughout the specification. It will be understood that, when an element is referred to as being “on” another element, it can be directly on another element or intervening elements may be present therebetween.

Exemplary embodiments represent ideal exemplary embodiments in detail. As a result, modifications of diagrams are expected. Accordingly, exemplary embodiments are not limited to specific shapes of shown regions and, for example, also include modifications of the shape by manufacture.

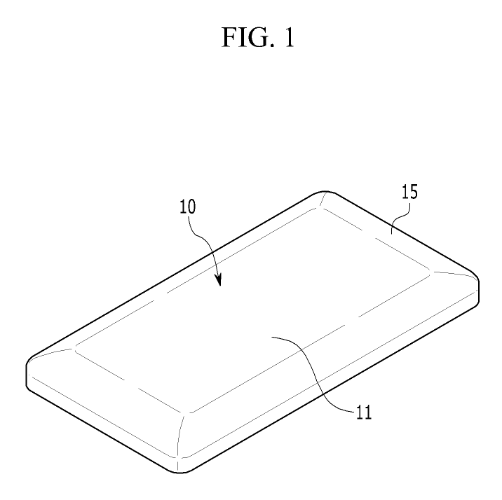

FIG. 1 shows a display glass window processed according to a first exemplary embodiment of the invention.

As shown in FIG. 1, a display glass window 10 processed according to the first exemplary embodiment includes a flat center portion 11 and an edge 15 processed so as to be rounded. In further detail, the edge of the display glass window 10 has a curved corner. That is, the display glass window 10 is formed in a shape that is similar to that of a lens. Thus, the display glass window 10 processed according to the first exemplary embodiment may partially function as a lens.

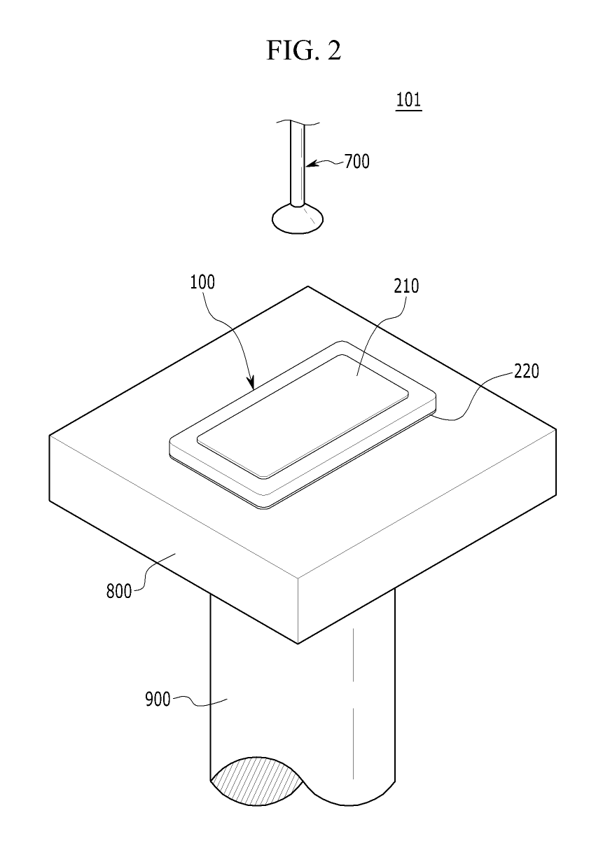

Hereinafter, a display glass window processing device according to the first exemplary embodiment will be described with reference to FIG. 2.

FIG. 2 is a perspective view of a device for processing the display glass window according to the first exemplary embodiment of the invention.

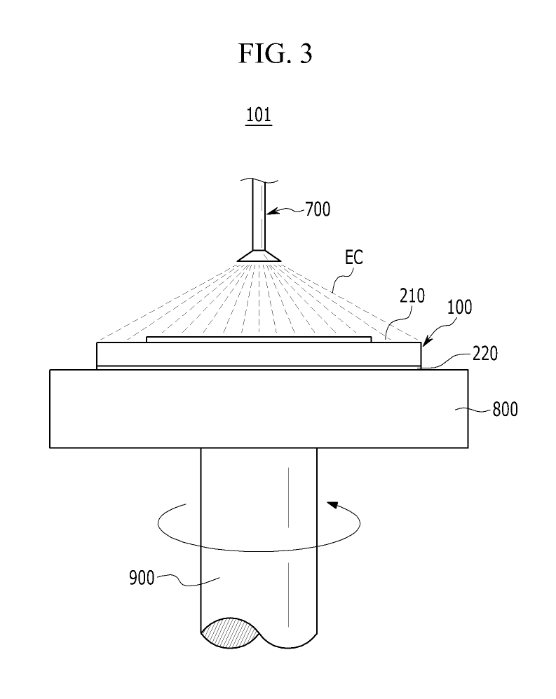

As shown in FIG. 2, a display glass window processing device 101 includes a worktable 800, a rotator 900, and a sprayer 700. In addition, the display glass window processing device includes an etchant (EC) (shown in FIG. 3) sprayed through the sprayer 700.

The display glass window processing device 101 may further include a first protection film 210 and a second protection film 220 respectively attached to opposite sides of an unprocessed glass 100.

The worktable 800 supports the unprocessed glass 100. The rotator 900 rotates the unprocessed glass 100 supported by the worktable 800. In this case, the rotator 900 may rotate the worktable 800 supporting the unprocessed glass 100 together with the unprocessed glass 100, or it may rotate the unprocessed glass 100 by providing a rotation tool (not shown) on the worktable 800. In this case, the worktable 800 should stably support the rotating processed glass 100.

The first protection film 210 is attached to one side of the unprocessed glass 100 arranged opposite the sprayer 700. The second protection film 220 is attached to the other side of the unprocessed glass 100 arranged opposite the worktable 800. In addition, the first protection film 210 is smaller in size than the second protection film 220. In further detail, the first protection film 210 may be attached to a part of one side of the unprocessed glass 100, and the second protection film 220 may be wholly attached to the other side of the unprocessed glass 100. However, the first exemplary embodiment is not limited thereto. Thus, the second protection film 220 may partially expose the other side of the unprocessed glass 100. However, in this case, the part of the other side of the unprocessed glass 100, which is exposed rather than being covered by the second protection film 220, is relatively smaller in size than a part of one side of the unprocessed glass 100 which is exposed rather than covered by the first protection film 210.

Furthermore, when the first protection film 210 is attached to the unprocessed glass 100, the edge of the unprocessed glass 100 is exposed. Thus, the edge of the unprocessed glass 100 is etched by the etchant EC (shown in FIG. 3), and thus becomes rounded. The edge of the unprocessed glass 100 may be effectively rounded because it is etched by the etchant EC while being rotated.

The first protection film 210 and the second protection film 220 are made of materials which are etching-resistive to the etchant that etches the unprocessed glass 100. For example, the first protection film 210 and the second protection film 220 may be made of materials having excellent chemical resistivity, such as polyethylene terephthalate (PET).

The sprayer 700 sprays the etchant toward the rotating unprocessed glass 100. In addition, the etchant processes the unprocessed glass 100 by etching the same. The other side of the unprocessed glass 100 is not etched because it is wholly covered by the second protection film 220, and the portion of one side of the unprocessed glass 100, which is exposed rather than covered by the first protection film 210, is etched by the etchant.

With such a configuration, the display glass window processing device 101 according to the first exemplary embodiment can effectively form the display glass window 10 of FIG. 1 by effectively processing the unprocessed glass 100 of FIG. 2.

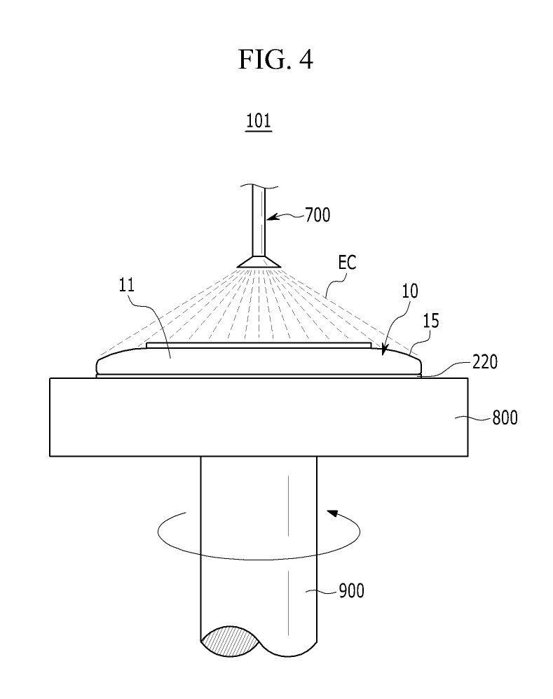

Hereinafter, a method for processing a display glass window using the display glass window processing device according to the first exemplary embodiment will be described with reference to FIG. 3 and FIG. 4.

FIG. 3 and FIG. 4 are side views sequentially illustrating a method for processing a display glass window according to the first exemplary embodiment of the invention.

First, as shown in FIG. 3, an unprocessed glass 100 is mounted on a worktable 800 and is then rotated by a rotator 900. In this case, a first protection film 210 is attached to one side of the unprocessed glass 100 and a second protection film 220 is attached to the other side of the unprocessed glass 100. The first protection film 210 is relatively smaller in size than the second protection film 220, and the first protection film 210 exposes the edge of the unprocessed glass 100.

Next, as shown in FIG. 4, when an etchant EC is sprayed onto the rotating unprocessed glass 100, the edge of the unprocessed glass 100 which is exposed rather than covered by the first protection film 210 is etched, and thus a display glass window 10, like the display glass window 10 shown in FIG. 1, is formed.

In this case, the edge of the unprocessed glass 100, which is exposed rather than covered by the first protection film 210, is relatively and gradually much more etched as it moves away from the rotator 900. In addition, the degree of etching is proportional to the rotation speed.

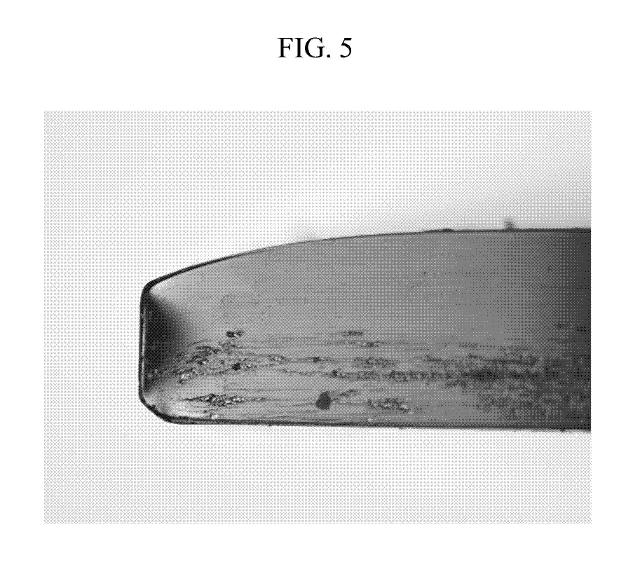

FIG. 5 is a partial cross-sectional view of the display glass window processed according to the first exemplary embodiment of the invention.

More specifically, FIG. 5 is a real image showing a cross-section of the edge of the display glass window processed according to the first exemplary embodiment. As shown in FIG. 5, the display glass window can have an effective curved edge according to the first exemplary embodiment.

Next, the display glass window 10, upon completion of processing, may experience a cleansing process.

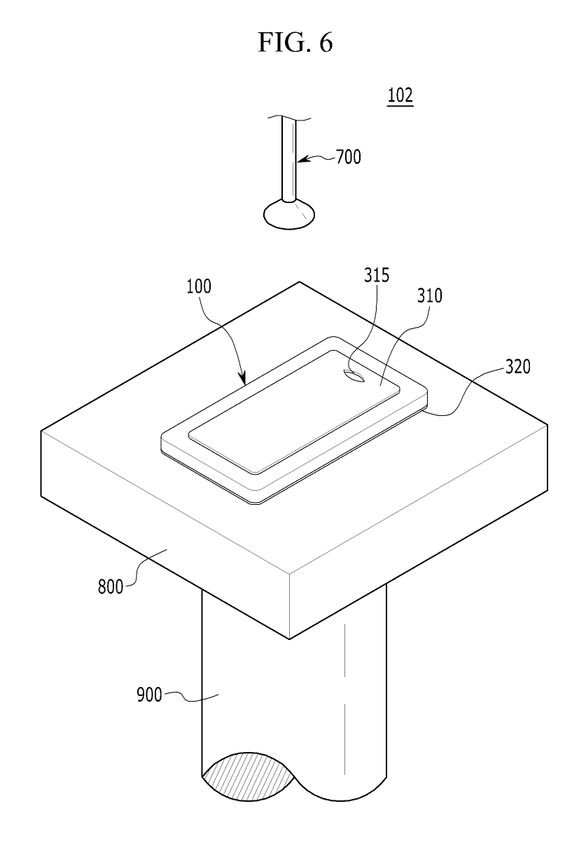

Hereinafter, a display glass window processing device according to a second exemplary embodiment will be described with reference to FIG. 6.

FIG. 6 is a perspective view of a device for processing a display glass window according to a second exemplary embodiment of the invention.

As shown in FIG. 6, the display glass window processing device 102 according to the second exemplary embodiment may include an opening pattern 315 having at least one of the shapes such as a diagram, a sign, a number, and a character formed in the first protection film 310. FIG. 6 illustrates that the opening pattern 315, as an example, has an oval shape. A second protection film 320 is the same as the second protection film 220 of the first exemplary embodiment of FIGS. 2 thru 4.

With such a configuration, the display glass window processing device 102 according to the second exemplary embodiment can easily form a groove having various patterns in one side of a display glass window. Such a pattern can improve functionality and added value of the display glass window.

In addition, the method for processing a display glass window according to the second exemplary embodiment is the same as that of the first exemplary embodiment except for the fact that the first protection film 310 has an opening pattern 315 formed therein.

While this disclosure has been described in connection with what is presently considered to be practical exemplary embodiments, it is to be understood that the invention is not limited to the disclosed embodiments but, on the contrary, is intended to cover various modifications and equivalent arrangements included within the spirit and scope of the appended claims.

What is claimed is:

1. A display glass window processing device, comprising:
a worktable for supporting an unprocessed glass;
a rotator for rotating the unprocessed glass; and
a sprayer for spraying an etchant onto the unprocessed glass.

2. The display glass window processing device of claim 1, further comprising a first protection film attached to one side of the unprocessed glass arranged opposite the sprayer, and a second protection film attached to another side of the unprocessed glass arranged opposite the worktable.

3. The display glass window processing device of claim 2, wherein the first protection film is smaller in size than the second protection film.

4. The display glass window processing device of claim 3, wherein the first protection film is attached to a part of said one side of the unprocessed glass, and the second protection film is wholly attached to said another side of the unprocessed glass.

5. The display glass window processing device of claim 2, wherein the first protection film is attached to the unprocessed glass so as to expose an edge of the unprocessed glass.

6. The display glass window processing device of claim 5, wherein the edge of the unprocessed glass is etched so as to be rounded.

7. The display glass window processing device of claim 5, wherein the edge of the unprocessed glass, exposed rather than being covered by the first protection film, is relatively and gradually etched as it moves away from the rotator.

8. The display glass window processing device of claim 7, wherein a degree of the etching is proportional to a rotation speed of the worktable.

9. The display glass window processing device of claim 2, wherein the first protection film and the second protection film are etching-resistive relative to the etchant.

10. The display glass window processing device of claim 1, wherein the first protection film has formed therein an opening pattern including at least one of a diagram, a sign, a number, and a character.

11. A method for processing a display glass window, comprising the steps of:
mounting an unprocessed glass on a worktable;
rotating the unprocessed glass; and
spraying an etchant onto the unprocessed glass.

12. The method for processing the display glass window of claim 11, further comprising the steps, before the spraying of the etchant, of attaching a first protection film to one side of the unprocessed glass arranged opposite the sprayer, and attaching a second protection film to another side of the unprocessed glass arranged opposite the worktable.

13. The method for processing the display glass window of claim 12, wherein the first protection film is smaller in size than the second protection film.

14. The method for processing the display glass window of claim 13, wherein the first protection film is attached to a part of said one side of the unprocessed glass, and the second protection film is wholly attached to said another side of the unprocessed glass.

15. The method for processing the display glass window of claim 12, wherein the first protection film is attached so as to expose an edge of the unprocessed glass.

16. The method for processing the display glass window of claim 15, wherein the edge of the unprocessed glass is etched so as to be rounded.

17. The method for processing the display glass window of claim 15, wherein the edge of the unprocessed glass, exposed rather than being covered by the first protection film, is relatively and gradually etched as it moves away from a rotator.

18. The method for processing the display glass window of claim 17, wherein a degree of the etching is proportional to a rotation speed of the worktable.

19. The method for processing the display glass window of claim 12, wherein the first protection film and the second protection film are etching-resistive relative to the etchant.

20. The method for processing the display glass window of claim 11, wherein the first protection film has formed therein an opening pattern including at least one of a diagram, a sign, a number, and a character.
